(19) United States
(12) Patent Application Publication
(10) Pub. No.: US 2026/0251551 A1
(43) Pub. Date: Aug. 27, 2026

(54) ENVIRONMENTAL TEST ENCLOSURE WITH RECIRCULATING INLET CONDITIONING AND AMBIENT-MIX CONTROL

(71) Applicant: Aivres Systems Inc., Fremont, CA (US)

(72) Inventor: Shin-Chi SHEN, Taipei City (TW)

(21) Appl. No.: 19/406,320

(22) Filed: Dec. 2, 2025

(51) Int. Cl. G01N 17/00

(52) U.S. Cl. CPC G01N 17/002

(57) ABSTRACT

An environmental test enclosure conditions the inlet air of a device under test (DUT) using a recirculating airflow loop that faces the DUT's intake side. Panels with insulating material form the loop, which includes an environment-conditioning device positioned upstream of the intake to add or remove heat and/or moisture. An ambient-air mixing aperture on the enclosure communicates the loop with room air to trim the inlet condition without dedicated chilling or additional heating. One or more sensors measure an inlet environmental parameter (e.g., temperature or relative humidity), and a controller maintains airflow toward the intake and coordinates the conditioning device output with the aperture setting. Exhaust air from the DUT is routed back toward the conditioning device to reuse waste heat, improving energy efficiency and test throughput.

### TECHNICAL FIELD

This disclosure relates to environmental testing of electronic equipment, and more particularly to enclosures that condition a device-under-test (DUT) inlet environment, temperature and/or humidity, using a recirculating airflow loop with coordinated conditioning and ambient-mix control.

### BACKGROUND

High-performance computing systems, AI accelerators, and dense server platforms impose stringent inlet-air requirements during durability and reliability testing. Conventional temperature and humidity chambers typically rely on integrated heaters and vapor-compression coolers to force the entire chamber volume to a setpoint. These systems are accurate but costly to acquire and operate, slow to schedule due to limited availability, and energy-intensive when testing high-heat-load devices whose own exhaust continuously perturbs the chamber environment.

In many server and accelerator configurations, the DUT's internal fans already establish a strong, directional inlet-to-exhaust airflow. Traditional chambers do not exploit that existing flow path, and instead treat the test volume as a uniform space, which can increase energy use and lengthen soak times. Moreover, when only elevated inlet temperature or modest humidity adjustment is required, full active cooling to sub-ambient conditions is unnecessary; yet chambers often modulate around setpoint with compressor duty cycles rather than by selectively admixing room air.

There is a need for a simpler enclosure architecture that conditions the DUT's inlet environment directly, reuses a portion of the DUT's exhaust through a recirculating loop to reduce energy consumption, and trims the inlet condition by controlled admission of ambient air. Such an approach should integrate easily with varied DUT form factors, leverage the DUT's fans for forced convection, and support straightforward closed-loop control using one or more inlet sensors.

### SUMMARY

A system of one or more computers can be configured to perform particular operations or actions by virtue of having software, firmware, hardware, or a combination of them installed on the system that, in operation, causes the system to perform the actions. One or more computer programs can be configured to perform particular operations or actions by virtue of including instructions that, when executed by data processing apparatus, cause the apparatus to perform the actions. Other embodiments of the described subject matter include corresponding computer systems, apparatus, and computer programs recorded on one or more computer storage devices, each configured to perform the actions of the methods.

In one general aspect, an environmental test enclosure includes panels having insulating material cooperatively arranged with a device under test (DUT) to form a recirculating airflow loop facing an intake side of the DUT. An environment-conditioning device is disposed in the recirculating airflow loop upstream of the intake side of the DUT and is configured to condition loop air by adding or removing heat and/or moisture. An ambient-air mixing aperture is formed on an exterior surface of the panels and communicates the recirculating airflow loop with ambient air. At least one sensor is configured to sense an inlet environmental parameter of the DUT. A controller is configured to maintain an airflow direction from the environment-conditioning device toward the intake side of the DUT and to regulate the inlet environmental parameter by coordinating an output of the environment-conditioning device and a setting of the ambient-air mixing aperture responsive to the sensed inlet environmental parameter. The recirculating airflow loop routes at least a portion of exhaust air from the DUT back toward the environment-conditioning device.

Implementations may include one or more of the following features. The environment-conditioning device can include a heater configured to add heat to air in the recirculating airflow loop; the at least one sensor can include a temperature sensor; and the controller can be configured to regulate an inlet temperature setpoint. The heater can include a heating plate or a power resistor coupled to an external power supply, and the controller can regulate heater output by adjusting delivered electrical power. In other implementations, the environment-conditioning device can include a cooling device configured to remove heat from air or add cold air in the recirculating airflow loop; the at least one sensor can include a temperature sensor; and the controller can be configured to regulate an inlet temperature setpoint. In yet other implementations, the environment-conditioning device can include a humidifier or a dehumidifier configured to adjust moisture content of air in the recirculating airflow loop; the at least one sensor can include a humidity sensor; and the controller can be configured to regulate an inlet relative-humidity setpoint.

The enclosure can include a sealable opening configured to receive the DUT and, when sealed, maintain the recirculating airflow loop. Airflow in the recirculating airflow loop can be driven by one or more fans of the DUT operating in forced convection or by one or more fans installed in the recirculating airflow loop. The controller can include a computer configured to receive the inlet environmental parameter sensed by the at least one sensor and automatically actuate the ambient-air mixing aperture and the output of the environment-conditioning device responsive to the inlet environmental parameter. The ambient-air mixing aperture can be motorized so the controller opens or closes the aperture responsive to the inlet environmental parameter. The ambient-air mixing aperture can be implemented as a sliding panel configured to open, close, partially open, or partially close, or as a hinged flap having a hinge along a downstream edge relative to the airflow direction and a free edge facing upstream, configured such that, when opened from the free edge, ambient air is admitted into the recirculating airflow loop in a direction substantially aligned with the airflow direction due to an established pressure differential. The ambient-air mixing aperture can be located downstream of the environment-conditioning device and upstream of the intake side of the DUT so that ambient air admitted tempers air exiting the environment-conditioning device before reaching the intake side of the DUT. The controller can implement a discrete update at successive sampling intervals using present and past temperature values and a setpoint to compute coordinated commands to the environment-conditioning device and the ambient-air mixing aperture. The panels can be selected from foamed plastics and aluminum-composite laminates, can form an annular or elliptical channel surrounding the intake side of the DUT, and can include a reflective inner surface to reduce radiative heat loss within the recirculating airflow loop.

In another general aspect, a method includes arranging panels having insulating material with the DUT to form a recirculating airflow loop facing an intake side of the DUT; operating an environment-conditioning device disposed in the recirculating airflow loop upstream of the intake side of the DUT to condition air in the recirculating airflow loop by adding or removing heat and/or moisture; admitting ambient air through an ambient-air mixing aperture configured on an exterior surface of the panels to communicate the recirculating airflow loop with ambient air; sensing, with at least one sensor, an inlet environmental parameter of the DUT; maintaining an airflow direction from the environment-conditioning device toward the intake side of the DUT; and regulating the inlet environmental parameter responsive to the sensed inlet environmental parameter by coordinating an output of the environment-conditioning device and a setting of the ambient-air mixing aperture. The method further includes routing at least a portion of exhaust air from the DUT back toward the environment-conditioning device in the recirculating airflow loop.

Method implementations may include one or more of the following features. The method can include executing a discrete closed-loop update at successive sampling intervals using present and past values of the inlet environmental parameter and a setpoint to compute coordinated commands to the environment-conditioning device and the ambient-air mixing aperture. The method in which admitting ambient air includes actuating a motorized ambient-air mixing aperture to open or close responsive to the inlet environmental parameter. Implementations of the described techniques may include hardware, a method or process, or a computer tangible medium.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 illustrates a traditional environmental test chamber for testing the durability or reliability of a device.

FIG. 2 illustrates a top view of an example environmental test enclosure with recirculating inlet conditioning and ambient-mix control, in accordance with some embodiments.

FIG. 3 illustrates an assembly process of a device under test (DUT) with the environmental test enclosure with recirculating inlet conditioning and ambient-mix control, in accordance with some embodiments.

FIG. 4 illustrates a perspective view of the environmental test enclosure with recirculating inlet conditioning and ambient-mix control, in accordance with some embodiments.

FIG. 5 illustrates another perspective view of the environmental test enclosure with recirculating inlet conditioning and ambient-mix control, in accordance with some embodiments.

FIG. 6 illustrates a workflow of using the environmental test enclosure with recirculating inlet conditioning and ambient-mix control, in accordance with some embodiments.

FIG. 7 illustrates an example method of controlling the environmental test enclosure with recirculating inlet conditioning and ambient-mix control, according to one example embodiment.

FIG. 8 illustrates a block diagram of an example computer system in which various of the embodiments described herein may be implemented.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

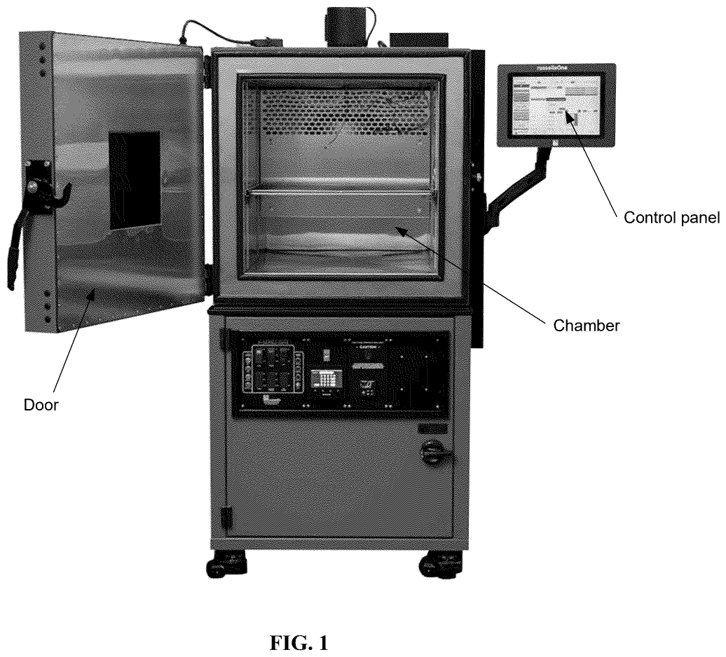

FIG. 1 shows a representative traditional environmental test chamber used to evaluate durability and reliability of a device under test (DUT). These chambers enclose the DUT within a rigid, insulated cabinet (chamber) accessed by a sealed door and operated through a control panel. In common configurations the chamber conditions the entire interior volume with integrated heaters and a vapor-compression cooling system that circulates a refrigerant (cold agent). Some models provide multiple zones (e.g., hot/cold) and rapidly transfer the DUT between them for thermal-shock profiles; others hold a single volume at a programmed temperature and/or humidity setpoint.

This architecture has practical limits for today's high-power compute hardware and fast development cycles. First, capacity and scheduling are constrained: large, compressor-based chambers are expensive, scarce assets, and soak times increase with load as the system cools or heats the full air mass and all interior hardware. Second, energy cost is high, when the chamber overshoots a temperature setpoint or must pull down from a heat step, the controller drives the compressor and refrigerant loop rather than exploiting ambient air, and the door remains closed to preserve control. Third, many server and accelerator DUTs already generate substantial directed airflow with their own fans. Conventional chambers treat the interior as a uniform space and do not leverage the DUT's intake/exhaust path, so waste heat is not recirculated in a controlled way to reach an inlet target efficiently.

For heat-tolerance screening (common for servers specified for operation at elevated inlet temperatures (e.g., 35° C.)), these constraints translate into cost, queue time, and unnecessary energy use. Teams often need a lightweight fixture that reaches and holds an inlet target quickly, with enough repeatability to decide whether a cooling solution is viable before booking a full certification run.

The enclosure disclosed herein addresses that need. Instead of conditioning the entire cabinet volume, the enclosure forms a recirculating airflow loop that faces the DUT's intake side, reuses a portion of the DUT's exhaust, and tempers the inlet stream with an ambient-air mixing aperture. In a heat-only configuration, the lowest attainable temperature is ambient; however, the loop's waste-heat recirculation allows rapid, energy-efficient ascent to elevated inlet setpoints without large compressors, and the aperture provides precise trimming by admitting room air rather than expending additional cooling power. The fixture is quick to assemble around varied DUT form factors, low cost, and well-suited for high-throughput pre-tests that screen designs and reduce dependence on scarce, expensive chambers. Traditional chambers remain appropriate for sub-ambient profiles, formal qualification, and multi-axis environmental stress, whereas the present enclosure provides a complementary, fast, and efficient path to validate heat (and, in some embodiments, humidity) performance early and often.

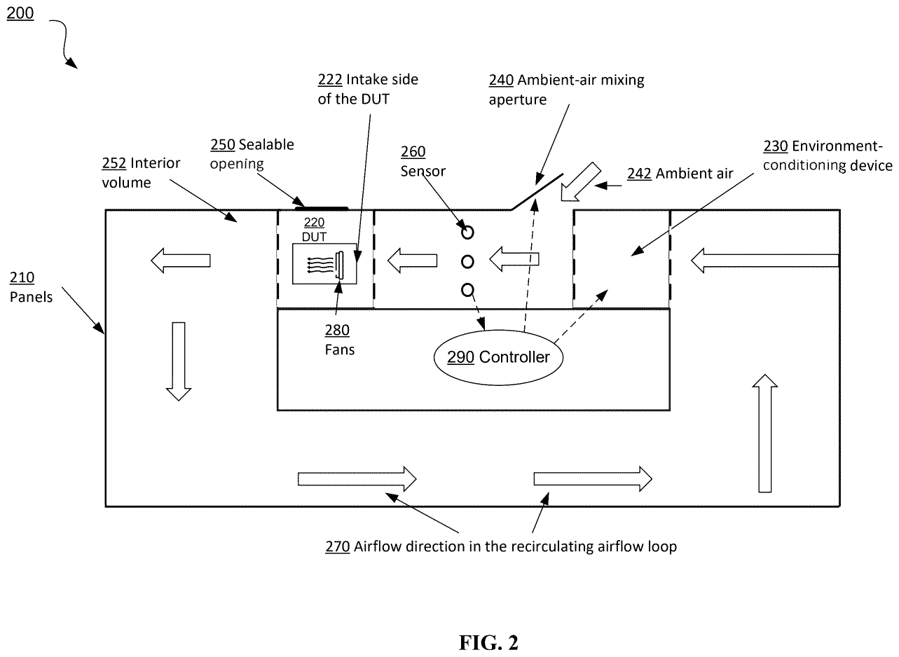

FIG. 2 illustrates a top view of an example environmental test enclosure 200 with recirculating inlet conditioning and ambient-mix control, in accordance with some embodiments. The enclosure 200 is formed by panels 210 (as a single casting or an assembly of panels). In some embodiments, the panels 210 include thermally insulating material that defines and confines a recirculating airflow loop.

In some embodiments, the panels 210 define an interior volume 252 having a sealable opening 250. The interior flow volume 252 is open at the sealable opening 250 and at designed interfaces (e.g., the ambient-air mixing aperture 240). As used here, “interior flow volume 252” refers to the continuous air space bounded by the panels 210; the dashed regions in FIG. 2 simply denote functional segments within that interior flow volume 252 and may not be physical partitions.

When a DUT 220 is inserted through the sealable opening 250 and the opening is sealed, the panels 210 cooperate with the DUT 220 to form the recirculating airflow loop. The loop is arranged to direct air toward an intake side of the DUT (labeled 222, i.e., the airflow-entry surface of the DUT), the air passes through the DUT 220 to an exhaust side of the DUT 220, and a portion of the exhaust is guided along a return path back toward an environment-conditioning device 230. As used here, “intake side” refers to the airflow-entry surface of the DUT, and “exhaust side” refers to the airflow-exit surface. Arrows 270 depict the airflow direction around the loop.

In some embodiments, an environment-conditioning device 230 is disposed upstream of the intake side 222 of the DUT 220 (e.g., along a supply segment of the loop) and conditions loop air by adding or removing heat and/or moisture before that air reaches the DUT intake side 222. In some embodiments, an ambient-air mixing aperture 240 is formed on an exterior surface of the panels 210 and communicates the loop with ambient air 242.

In some embodiments, a controller 290 is operatively coupled to the environment-conditioning device 230 and the ambient-air mixing aperture 240 and adjusts the inlet condition by coordinating the output of the environment-conditioning device 230 with a setting of the ambient-air mixing aperture 240 to admit ambient air 242, while maintaining the established recirculating flow toward the intake side 222.

In some embodiments, one or more sensors 260 are positioned to sense an inlet environmental parameter (also referred to as “an inlet parameter,” e.g., temperature and/or relative humidity) at or near the intake side 222 of the DUT 220. Responsive to the sensed value (i.e. the inlet environmental parameter), the controller 290 maintains airflow from the environment-conditioning device 230 toward the intake side 222 and regulates the inlet parameter by coordinating an output of the environment-conditioning device 230 and a setting of the ambient-air mixing aperture 240. In some embodiments the controller 290 may be implemented as a computer, industrial server, microcontroller, or programmable logic device executing control software. The controller is configured to receive digitized readings from the sensors 260 and actuates both the environment-conditioning device 230 and a motorized ambient-air mixing aperture 240. In some embodiments the controller 290 executes a discrete closed-loop update at successive sampling intervals using present and past values of the inlet parameter and a setpoint to compute coordinated commands to the environment-conditioning device 230 and the ambient-air mixing aperture 240.

As shown, the recirculating loop (indicated by the airflow direction 270) is arranged so that at least a portion of air exhausted from the DUT 220 returns toward the environment-conditioning device 230. This arrangement reuses waste heat during heat profiles, accelerating rise to elevated inlet temperatures and reducing the energy needed to reach or maintain a temperature setpoint. In the illustrated layout, the ambient-air mixing aperture 240 is located downstream of the environment-conditioning device 230 and upstream of the intake side 222 of the DUT 220 so that ambient air 242 admitted through the aperture 240 tempers air exiting the environment-conditioning device 230 before the mixture reaches the DUT intake side 222.

Airflow in the loop can be produced in different ways. In some embodiments, internal fans 280 of the DUT 220 establish forced convection from the intake side 222 through the DUT 220 and into the return path of the loop; the enclosure 200 leverages this existing flow to circulate air around the loop. In other embodiments, one or more auxiliary fans may be mounted within the loop to provide air flow, for example when the DUT 220 is unpowered or operates at low airflow, or the airflow direction of the DUT 220 is not aligned with the desired airflow direction.

The ambient-air mixing aperture 240 can be implemented with various mechanisms. In some embodiments, the ambient-air mixing aperture 240 is motorized and the controller 290 opens or closes the aperture responsive to the inlet parameter. In some embodiments the ambient-air mixing aperture 240 includes a sliding panel configured to translate to vary an opening area (e.g., open, partially open, or closed). In other embodiments the ambient-air mixing aperture 240 includes a hinged flap having a hinge along a downstream edge relative to airflow from the environment-conditioning device 230 toward the intake side 222 and a free edge facing upstream; when opened at the free edge, ambient air 242 is admitted into the loop in a direction substantially aligned with the established airflow due to a pressure differential.

In some embodiments, the environment-conditioning device 230 is adaptable to multiple test modalities. In some embodiments the environment-conditioning device 230 comprises a heater (e.g., a heating plate or a power resistor coupled to an external power supply), and the sensors 260 include a temperature sensor; the controller 290 regulates delivered electrical power to hold an inlet temperature setpoint. In other embodiments, the environment-conditioning device 230 comprises a cooling device (e.g., a vapor-compression cooler or a thermoelectric cooler) configured to remove heat from loop air while the controller regulates an inlet temperature setpoint. In other embodiments, the environment-conditioning device 230 comprises a humidifier and/or a dehumidifier to adjust moisture content of loop air, with the sensors 260 including a humidity sensor and the controller 290 regulating an inlet relative-humidity setpoint.

In practice, the panels 210 are selected to reduce losses to ambient and to withstand repeated use. In some embodiments the panels 210 include foamed plastics and/or aluminum-composite laminates, and interior panel surfaces are reflective to reduce radiative heat loss within the loop. In some embodiments, the reflective inner surface is provided on the loop-facing side of the panels 210 (i.e., the surfaces bounding the interior flow volume), for example as a bonded metallized film or polished aluminum layer having low emissivity to reduce radiative exchange with the conditioned air. This reduces heat gain or loss to the panels, allowing the enclosure to reach and hold setpoints faster with lower energy input and improved temperature uniformity at the DUT intake. The recirculating loop geometry can be tailored to the form factor of the DUT 220; for example, in some embodiments it is formed as an annular or elliptical channel surrounding the intake side 222 to promote uniform approach conditions.

The sealable opening 250 allows lateral installation of the DUT 220 and, when sealed (e.g., with a gasketed frame or tape) maintains loop integrity with minimal bypass leakage. Together, the panels 210, environment-conditioning device 230, ambient-air mixing aperture 240, sensors 260, fans 280, and controller 290 provide a compact, energy-efficient enclosure that rapidly establishes and holds a desired inlet environment while routing at least a portion of DUT exhaust back toward the environment-conditioning device 230 along the recirculating airflow loop.

In some embodiments, the dashed lines/boundaries in FIG. 2 delineate functional segments of the recirculating airflow loop, such as the region for receiving the DUT, the region for installing the sensors, and the region for hosting the environment-conditioning device 230. In practice, these lines need not correspond to any solid wall, grid, or baffle. The interior volume 252 may remain substantially open (throughout of the loop) to maximize flow area and reduce pressure drop, with the airflow path established by the relative placement of the DUT 220, fans 280, the environment-conditioning device 230, and the ambient-air mixing aperture 240. In other embodiments, optional flow-guiding elements (for example, low-impedance screens or vanes) may be added to shape the recirculation without departing from the open-volume configuration.

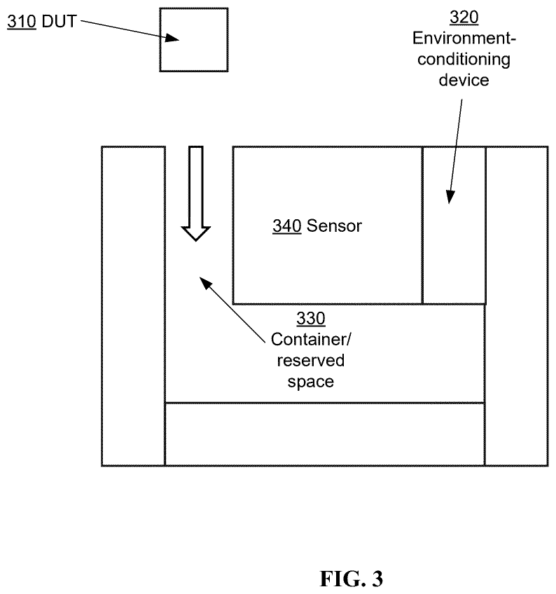

FIG. 3 illustrates an assembly process for installing a DUT 310 into an environmental test enclosure having recirculating inlet conditioning and ambient-mix control, in accordance with some embodiments. In the illustrated example, an environment-conditioning device 320 is preinstalled within the enclosure and defines the modality of the test. For a heat-tolerance profile, the environment-conditioning device 320 is a heater that raises loop air temperature upstream of the DUT intake; the maximum attainable inlet temperature is set by the heater capacity, whereas the minimum attainable temperature is approximately the ambient air temperature because the ambient-air mixing aperture can admit room air to trim downward without dedicated cooling. In a cooling configuration, the environment-conditioning device 320 is a cooling device that removes heat from loop air; the aperture can admit warmer ambient air to trim upward toward a target. In a humidity configuration, the environment-conditioning device 320 comprises a humidifier and/or dehumidifier that adjusts loop moisture content; the aperture provides coarse trimming by mixing room air with the conditioned stream.

In some embodiments, the reserved space or container 330 may be configured to introduce negligible flow resistance and avoid blocking the airflow (e.g., realized as an open frame or low-profile guides with generous cross-sectional area, rounded edges, and optional perforated brackets, along the airflow direction), so the pressure drop and flow disturbance at the DUT intake are minimized.

To form the recirculating loop, the DUT 310 is inserted into the enclosure through an opening and seated against guides or supports within the reserved space or container 330. The opening is then sealed to prevent bypass leakage and to maintain the loop; suitable sealing implementations may include a gasketed frame, compressible foam, magnetic or mechanical clamps, or tape across the gap between the panels and the DUT chassis. Once sealed, the enclosure panels and the DUT 310 cooperate to establish a recirculating path that directs air from the environment-conditioning device 320 toward the DUT intake side, through the DUT 310 (e.g., testing the DUT's thermal tolerance), and back along a return segment toward the environment-conditioning device 320.

This lightweight architecture is tailored for streamlined single-modality screens such as heat-tolerance testing of servers. By recirculating a portion of the DUT's exhaust, the loop reuses waste heat to rise quickly to an elevated setpoint with reduced energy input. During pull-down or fine control, the ambient-air mixing aperture admits room air instead of relying on compressor cycles, further improving efficiency and shortening stabilization time. As a result, the enclosure enables fast, low-cost, and repeatable pre-tests that decongest access to large, expensive multi-purpose chambers while preserving compatibility with varied DUT form factors.

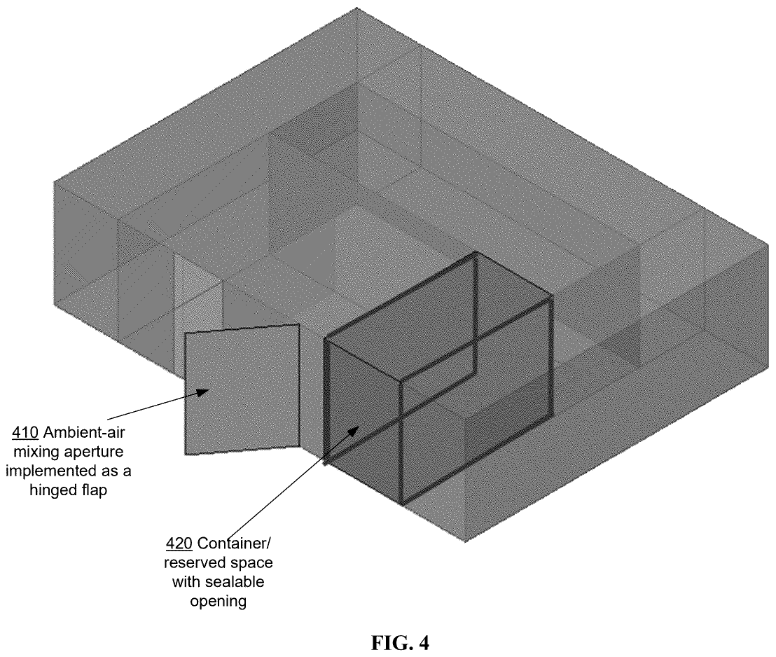

FIG. 4 illustrates a perspective view of the environmental test enclosure with recirculating inlet conditioning and ambient-mix control, in accordance with some embodiments. As shown, a container or reserved space 420 with a sealable opening receives the DUT and, when sealed, cooperates with surrounding panels to complete the recirculating airflow loop described above. An ambient-air mixing aperture 410 is formed on an exterior surface of the enclosure.

In the embodiment shown, the aperture 410 is implemented as a hinged flap (or cap). The hinge is located along a downstream edge relative to the loop's supply-segment airflow (i.e., closer to the DUT), and the free edge faces upstream (i.e., closer to the environment-conditioning device). When air in the supply segment moves quickly toward the DUT intake, its velocity pressure rises and its static pressure drops to keep total pressure roughly constant along a streamline (Bernoulli principle). The room side near the flap is nearly stagnant and thus at higher static pressure. This ambient-internal static pressure difference creates a net inward force that tips the downstream-hinged flap open and draws ambient air into the loop. In addition, this orientation of the aperture 410 minimizes separation and back-eddies at the opening, promotes rapid mixing, and reduces losses.

Although a hinged flap is illustrated, other mechanisms can realize the aperture 410, including a sliding panel with a controllable opening area or a motorized louver. The hinged geometry is advantageous for passive, airflow-assisted admission of ambient air without additional actuators, while still allowing active actuation when coupled to the controller.

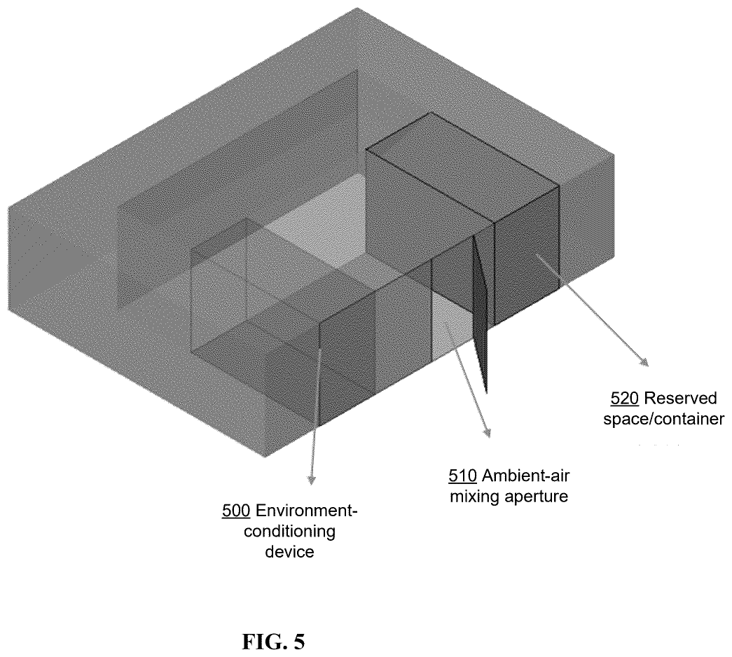

FIG. 5 illustrates another perspective view of an environmental test enclosure in which an environment-conditioning device 500 is disposed upstream of the DUT intake within the recirculating loop, and an ambient-air mixing aperture 510 is formed on an exterior surface of the panels (e.g., the top cover or a side wall) to communicate the loop with ambient air. A reserved space or container 520 is provided to receive the DUT and, when closed, cooperate with the surrounding panels to maintain the recirculating airflow loop while leaving an open, low-restriction tunnel for approach flow to the DUT intake.

In some embodiment, the reserved space or container 520 is implemented as a tunnel whose interior cross-section remains open to airflow but is sealed from the exterior after installation of the DUT. In some embodiment, the tunnel includes a fixed bottom wall that provides support and alignment for the DUT chassis, and one or more retractable sections on the upper, front, and/or rear sides (in some cases, one or two of three sides being retractable is sufficient). During loading, the retractable section is moved to an open position to create a wide insertion window; after the DUT is positioned, the section is translated back to a closed position to form an airtight boundary to the outside while preserving the internal flow area. The retractable section may be realized as a telescoping panel set that nests into the tunnel wall, a sliding shutter that travels in a guide track, or a roll-up flexible membrane that spools into a housing and unrolls to close. Compressible gaskets around the moving edges seal against the DUT perimeter or fixed tunnel features when closed.

Alternative implementations of the reserved space 520 can be used without departing from the recirculating-loop concept. In some embodiments, the tunnel employs a bellows or accordion skirt that expands to admit the DUT and then collapses to seal, with an inflatable bladder or magnetic clamp providing final compression against the DUT chassis for low leakage. The tunnel geometry preserves an unobstructed approach stream to the DUT intake and, once closed, prevents bypass to ambient so that a portion of the DUT exhaust is routed back toward the environment-conditioning device 500 along the recirculating loop, while the ambient-air mixing aperture 510 provides controlled admission of room air as previously described.

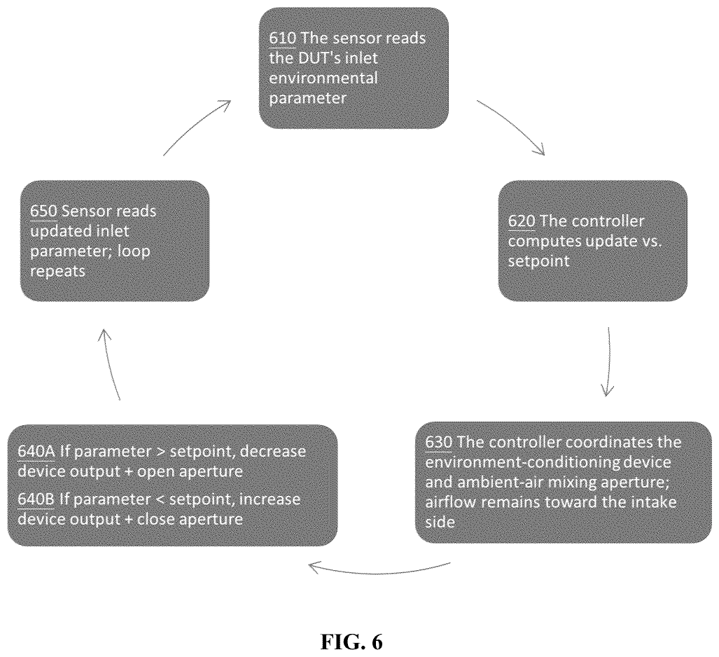

FIG. 6 illustrates a workflow of using the environmental test enclosure with recirculating inlet conditioning and ambient-mix control, in accordance with some embodiments.

At step 610, a sensor (e.g., temperature or humidity sensor) positioned proximate to the DUT intake reads the DUT's inlet environmental parameter. At step 620, a controller computes an update relative to a user-defined setpoint. At step 630, the controller coordinates the environment-conditioning device (e.g., heater, cooler, humidifier/dehumidifier) and the ambient-air mixing aperture so that the commanded actions maintain airflow toward the DUT intake while driving the inlet parameter toward the setpoint.

In some embodiments, the controller applies a decision logic: if the measured inlet parameter exceeds the setpoint (step 640A), the controller decreases the output of the environment-conditioning device and opens the ambient-air mixing aperture to admit ambient air; if the measured inlet parameter is below the setpoint (step 640B), the controller increases the device output and closes the aperture to reduce dilution. The sensor then acquires an updated value at the next sampling instant (step 650), and the loop repeats at a fixed or programmable sampling interval.

In some embodiments, the controller executes a discrete, proportional-integral-derivative (PID) update. For a temperature use case, let T(k) denote the inlet temperature at the k-th sample, Tsp denote the temperature setpoint, and Fs(k) denote the heater output command at sample k (e.g., delivered electrical power). The update may be expressed as:

$$Fs ( k ) = F s ( k - 1 ) + Kp \cdot [ T ( k ) - T ( k - 1 ) ] + Ki \cdot [ T ( k ) - Tsp ] + Kd \cdot [ T ( k ) - 2 \cdot T ( k - 1 ) + T ( k - 2 ) ] ,$$

where Kp, Ki, and Kd are tunable gains selected for the installation and ambient conditions. The controller maps Fs(k) to actuator signals (e.g., PWM or DAC for heater/cooler power) and simultaneously sets an aperture position based on the same error term so that heat addition/removal and ambient-air mixing are coordinated. In other words, the controller performs the discrete update at each sampling interval and issues synchronized commands to both the environment-conditioning device and the ambient-air mixing aperture. Analogous formulations apply to humidity control by substituting a humidity measurement for T and driving a humidifier/dehumidifier as the environment-conditioning device.

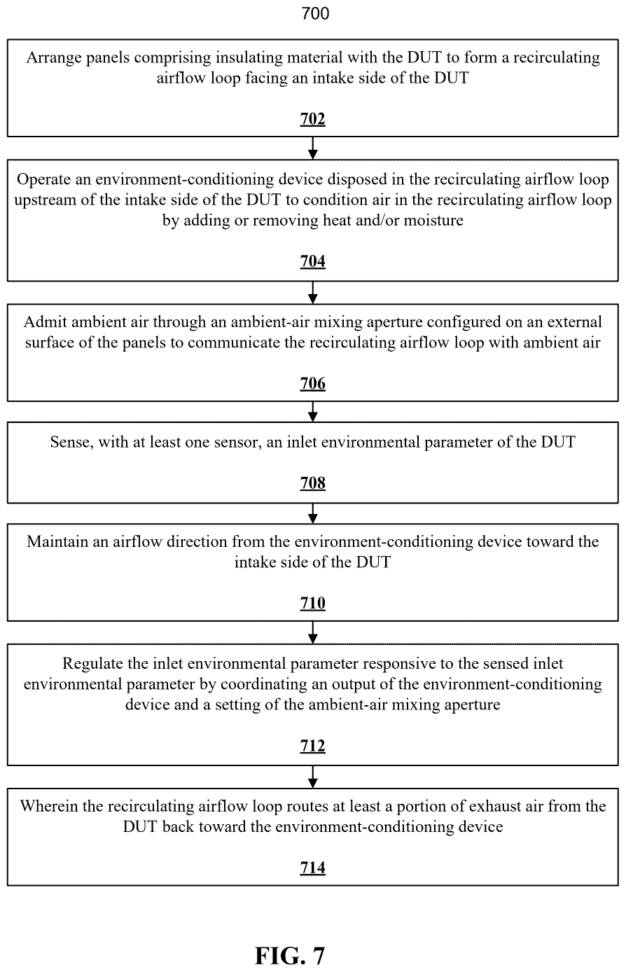

FIG. 7 illustrates an example method of controlling the environmental test enclosure with recirculating inlet conditioning and ambient-mix control, according to one example embodiment. In some implementations, one or more process blocks of FIG. 7 may be performed by a device.

As shown in FIG. 7, process 700 may include arranging panels having insulating material with the DUT to form a recirculating airflow loop facing an intake side of the DUT (block 702). For example, the device may arrange panels having insulating material with the DUT to form a recirculating airflow loop facing an intake side of the DUT, as described above. As also shown in FIG. 7, process 700 may include operating an environment-conditioning device disposed in the recirculating airflow loop upstream of the intake side of the DUT to condition air in the recirculating airflow loop by adding or removing heat and/or moisture (block 704). For example, the device may operate an environment-conditioning device disposed in the recirculating airflow loop upstream of the intake side of the DUT to condition air in the recirculating airflow loop by adding or removing heat and/or moisture, as described above. As further shown in FIG. 7, process 700 may include admitting ambient air through an ambient-air mixing aperture configured on an exterior surface of the panels to communicate the recirculating airflow loop with ambient air (block 706). For example, the device may admit ambient air through an ambient-air mixing aperture configured on an exterior surface of the panels to communicate the recirculating airflow loop with ambient air, as described above. As also shown in FIG. 7, process 700 may include sensing, with at least one sensor, an inlet environmental parameter of the DUT (block 708). For example, the device may sense, with at least one sensor, an inlet environmental parameter of the DUT, as described above. As further shown in FIG. 7, process 700 may include maintaining an airflow direction from the environment-conditioning device toward the intake side of the DUT (block 710). For example, the device may maintain an airflow direction from the environment-conditioning device toward the intake side of the DUT, as described above. As also shown in FIG. 7, process 700 may include regulating the inlet environmental parameter responsive to the sensed inlet environmental parameter by coordinating an output of the environment-conditioning device and a setting of the ambient-air mixing aperture (block 712). For example, the device may regulate the inlet environmental parameter responsive to the sensed inlet environmental parameter by coordinating an output of the environment-conditioning device and a setting of the ambient-air mixing aperture, as described above. As further shown in FIG. 7, process 700 may include routing at least a portion of exhaust air from the DUT back toward the environment-conditioning device in the recirculating airflow loop (block 714). For example, the device may route at least a portion of exhaust air from the DUT back toward the environment-conditioning device in the recirculating airflow loop, as described above.

Process 700 may include additional implementations, such as any single implementation or any combination of implementations described below and/or in connection with one or more other processes described elsewhere herein. In a first implementation, process 700 further includes executing a discrete closed-loop update at successive sampling intervals using present and past values of the inlet environmental parameter and a setpoint to compute coordinated commands to the environment-conditioning device and the ambient-air mixing aperture.

In a second implementation, alone or in combination with the first implementation, admitting ambient air may include actuating a motorized ambient-air mixing aperture to open or close responsive to the inlet environmental parameter.

Although FIG. 7 shows example blocks of process 700, in some implementations, process 700 may include additional blocks, fewer blocks, different blocks, or differently arranged blocks than those depicted in FIG. 7. Additionally or alternatively, two or more of the blocks of process 700 may be performed in parallel.

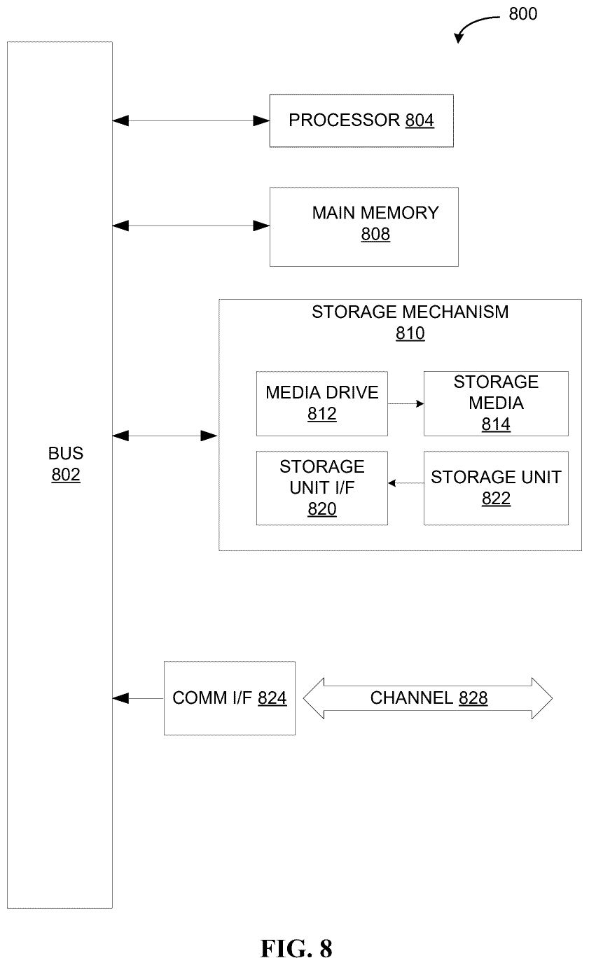

FIG. 8 illustrates an example computing system 800 that may be used in implementing various features of embodiments of the disclosed technology.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface 824 or network interface(s). Communications or network interface(s) interface 824 might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 828. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. An environmental test enclosure for testing durability or reliability of a device under test (DUT), comprising:
panels comprising insulating material configured to cooperate with the DUT to form a recirculating airflow loop facing an intake side of the DUT;
an environment-conditioning device disposed upstream of the intake side of the DUT in the recirculating airflow loop, the environment-conditioning device configured to condition air in the recirculating airflow loop by adding or removing heat and/or moisture;
an ambient-air mixing aperture configured on an exterior surface of the panels to communicate the recirculating airflow loop with ambient air;
at least one sensor configured to sense an inlet environmental parameter of the DUT; and
a controller configured to:
maintain an airflow direction from the environment-conditioning device toward the intake side of the DUT, and
coordinate an output of the environment-conditioning device and a setting of the ambient-air mixing aperture responsive to the sensed inlet environmental parameter;
wherein the recirculating airflow loop routes at least a portion of exhaust air from the DUT back toward the environment-conditioning device.

2. The environmental test enclosure of claim 1, wherein the environment-conditioning device comprises a heater configured to add heat to air in the recirculating airflow loop,
the at least one sensor comprises a temperature sensor, and
the controller is configured to regulate an inlet temperature setpoint.

3. The environmental test enclosure of claim 1, wherein the environment-conditioning device comprises a cooling device configured to remove heat from air or add cold air in the recirculating airflow loop,
the at least one sensor comprises a temperature sensor, and
the controller is configured to regulate an inlet temperature setpoint.

4. The environmental test enclosure of claim 1, wherein the environment-conditioning device comprises a humidifier or a dehumidifier configured to adjust moisture content of air in the recirculating airflow loop,
the at least one sensor comprises a humidity sensor, and
the controller is configured to regulate an inlet relative-humidity setpoint.

5. The environmental test enclosure of claim 1, further comprising:
a sealable opening configured on the environmental test enclosure to receive the DUT and, when sealed, maintain the recirculating airflow loop.

6. The environmental test enclosure of claim 1, wherein airflow in the recirculating airflow loop is driven by one or more fans of the DUT operating in forced convection.

7. The environmental test enclosure of claim 1, wherein airflow in the recirculating airflow loop is driven by one or more fans in the recirculating airflow loop.

8. The environmental test enclosure of claim 1, wherein the controller comprises a computer configured to receive the inlet environmental parameter sensed by the at least one sensor and automatically actuate the ambient-air mixing aperture and the output of the environment-conditioning device responsive to the sensed inlet environmental parameter.

9. The environmental test enclosure of claim 1, wherein the ambient-air mixing aperture is motorized and the controller is configured to open or close the ambient-air mixing aperture responsive to the inlet environmental parameter.

10. The environmental test enclosure of claim 1, wherein the ambient-air mixing aperture comprises a sliding panel configured to open, close, partially open, or partially close.

11. The environmental test enclosure of claim 1, wherein the ambient-air mixing aperture comprises a hinged flap,
the hinged flap comprising a hinge along a downstream edge relative to the airflow direction and a free edge facing upstream,
the hinged flap being configured such that, when opened from the free edge, ambient air is admitted into the recirculating airflow loop in a direction substantially aligned with the airflow direction due to an established pressure differential.

12. The environmental test enclosure of claim 2, wherein the heater comprises a heating plate or a power resistor coupled to an external power supply, and the controller regulates an output of the heater by adjusting a delivered electrical power.

13. The environmental test enclosure of claim 1, wherein the ambient-air mixing aperture is located downstream of the environment-conditioning device and upstream of the intake side of the DUT so that ambient air admitted tempers air exiting the environment-conditioning device before reaching the intake side of the DUT.

14. The environmental test enclosure of claim 1, wherein the controller implements a discrete update at successive sampling intervals using present and past temperature values and a setpoint to compute coordinated commands to the environment-conditioning device and the ambient-air mixing aperture.

15. The environmental test enclosure of claim 1, wherein the panels are selected from foamed plastics and aluminum-composite laminates.

16. The environmental test enclosure of claim 1, wherein the recirculating airflow loop is formed as an annular or elliptical channel surrounding the intake side of the DUT.

17. The environmental test enclosure of claim 1, wherein the panels comprise a reflective inner surface to reduce radiative heat loss within the recirculating airflow loop.

18. A method of conditioning inlet air for a device under test (DUT), comprising:
arranging panels comprising insulating material with the DUT to form a recirculating airflow loop facing an intake side of the DUT;
operating an environment-conditioning device disposed upstream of the intake side of the DUT in the recirculating airflow loop to condition air in the recirculating airflow loop by adding or removing heat and/or moisture;
admitting ambient air through an ambient-air mixing aperture configured on an exterior surface of the panels to communicate the recirculating airflow loop with ambient air;
sensing, with at least one sensor, an inlet environmental parameter of the DUT;
maintaining an airflow direction from the environment-conditioning device toward the intake side of the DUT; and
responsive to the sensed inlet environmental parameter, coordinating an output of the environment-conditioning device and a setting of the ambient-air mixing aperture;
wherein the recirculating airflow loop routes at least a portion of exhaust air from the DUT back toward the environment-conditioning device.

19. The method of claim 18, further comprising:
executing a discrete closed-loop update at successive sampling intervals using present and past values of the inlet environmental parameter and a setpoint to compute coordinated commands to the environment-conditioning device and the ambient-air mixing aperture.

20. The method of claim 18, wherein admitting ambient air comprises:
actuating a motorized ambient-air mixing aperture to open or close responsive to the inlet environmental parameter.
